(19) United States
(12) Patent Application Publication
(10) Pub. No.: US 2016/0144544 A1
(43) Pub. Date: May 26, 2016

(54) Ejector pin and method manufacturing the same

(71) Applicant: Infineon Technologies AG, Neubiberg (DE)

(72) Inventors: Sin Siew GARY LEE, Melaka (MY); Ping Ying KOK, Meleka (MY)

(21) Appl. No.: 14/951,861

(22) Filed: Nov. 25, 2015

(30) Foreign Application Priority Data
Nov. 26, 2014 (DE) 10 2014 117 353.8

(51) Int. Cl. B29C 45/40; B29C 70/68; B29C 70/74; B29C 45/02

(52) U.S. Cl. CPC B29C 45/401; B29C 45/02; B29C 70/682; B29C 70/683; B29C 70/745; B29L 2031/3481

(57) ABSTRACT

Various embodiments provide an ejector pin for a mold, wherein the ejector pin comprises a pin shaft comprising a pinhead at one end and a butting region at the opposite end of the pin shaft, wherein a circumferential groove formed in the pin shaft in the butting region.

### TECHNICAL FIELD

Various embodiments relate to an ejector pin, a method of manufacturing an ejector pin and a mold comprising an ejector pin, in particular a mold for forming an encapsulation for a semiconductor package.

### BACKGROUND

In the field of manufacturing semiconductor packages or electronic modules often molds are used for forming encapsulations for the packages. From US 2007/059860 A a method for forming a semiconductor package is known. A mold for encapsulating a chip having bonding wires with a molt resin is provided with at least one first half having an ejector-pin-through-hole and at least one second half coupled together to form a cavity therebetween. An ejector pin having a mirror-finished surface at a tip end thereof is inserted into the ejector-pin-through-hole and positioned at a position where a surface of the tip end of the ejector pin coincides with an intermediate surface height of a satin-finished surface formed on an upper inner wall of the cavity of the first half. The chip is then encapsulated with a molt resin, and the mirror-finished surface of the ejector pin and the satin-finished surface of the upper inner wall surface of the cavity are stamped on the semiconductor package in substantially the same plane.

A schematic layout of a mold 500 including or forming a cavity is shown in FIG. 5. In particular, FIG. 5A shows a mold 500 comprising a mold casing or mold housing 501 forming a mold cavity 502 and comprising a through or ejector pin hole leading from an external side to the mold cavity 502. An ejector pin 503 is fed through the through hole. As can be seen in FIG. 5B (which is a detail of the mold 500 of FIG. 5A) the through hole 510 has a larger diameter than a shaft of the ejector pin 503 so that a gap 511 is formed. Such a gap of about 5 micrometer is necessary to reduce friction between the ejector pin and the mold casing or housing to enable a movement of the ejector pin in the through hole so that a ready encapsulation formed in the mold cavity can be ejected out of the mold cavity.

### SUMMARY

Various embodiments provide an ejector pin for a mold, wherein the ejector pin comprises a pin shaft comprising a pinhead at one end and a butting region at the opposite end of the pin shaft, wherein a circumferential groove is formed in the pin shaft at the butting region.

Furthermore, various embodiments provide a mold comprising a mold housing comprising a through hole; and an ejector pin, wherein the ejector pin comprises a pin shaft comprising a pinhead at one end and a butting region at the opposite end of the pin shaft, wherein a circumferential groove formed in the pin shaft in the butting region; and wherein the ejector pin is inserted in the through hole.

Moreover, various embodiments provide a method of forming an ejector pin, wherein the method comprises providing a pin shaft comprising a pinhead at one end and a butting region at the opposite end of the pin shaft, wherein a circumferential groove formed in the pin shaft at the butting region

### BRIEF DESCRIPTION OF THE DRAWINGS

In the drawings, like reference characters generally refer to the same parts throughout the different views. The drawings are not necessarily to scale. Instead emphasis is generally being placed upon illustrating the principles of the invention. In the following description, various embodiments are described with reference to the following drawings, in which:

FIGS. 1A to 1D schematically illustrate a first cycle of a molding process using a mold according to an exemplary embodiment;

FIG. 2 schematically shows an ejector pin according to an exemplary embodiment in detail;

FIG. 3 schematically shows an ejector pin according to an exemplary embodiment;

FIG. 4 illustrates a flowchart of a method of manufacturing an ejector pin according to an exemplary embodiment; and

FIGS. 5A and 5B schematically show a schematic layout of a mold.

### DETAILED DESCRIPTION

In the following further exemplary embodiments of an ejector pin, a mold and a method of manufacturing an ejector pin will be explained. It should be noted that the description of specific features described in the context of one specific exemplary embodiment may be combined with others exemplary embodiments as well.

The word “exemplary” is used herein to mean “serving as an example, instance, or illustration”. Any embodiment or design described herein as “exemplary” is not necessarily to be construed as preferred or advantageous over other embodiments or designs.

Various exemplary embodiments provide an ejector pin comprising a groove or depression feature at a tip end of a shaft of the ejector pin opposite to a head end of the pin shaft. Such ejector pins can be utilized in molds during the molding process by introducing them into through holes or ejector pin holes in mold casings and used to separate the molded material and the mold casing from each other. In other words exemplary embodiments provide an ejector pin for a mold casing which comprises a feature (formed on or in the ejector pin) that obstructs or stops molding compound or resin from penetrating into a gap between the ejector pin and the ejector pin hole in the mold casing.

In particular, the term “butting region” may particularly denote the region which is close to a tip end of the pin shaft, wherein the tip end forms the end of the pin shaft which is opposite to the pinhead. Thereby the term “close” to the tip end” may particularly denote that the respective region forms at most the last 10% of pin shaft length from the pinhead to the tip end. In particular, the butting region may be formed by the last 5%, e.g. may be formed by the last 2.5%. It should be noted that the pin shaft may have a cylindrical shape a polyhedral shape or any other suitable shape or form.

By providing an ejector pin having a groove or depression feature at or close to the tip end of the pin shaft it may be possible to reduce the amount of flashes of molding material which may otherwise accumulate in the hole. These flashes are typically formed during the molding process by mold residuals sticking on the ejector pin and removed from the same when the ejector pin is retracted when separating the molded encapsulation and the mold casing. Thus, it may be possible to avoid that these flashes fall off and contaminate mold encapsulations subsequently formed by using the same mold casing.

Furthermore, the groove feature may also led to the effect that a bleeding into the gap between mold casing and the ejector pin during the molding process by acting as a kind of stopper or seal. Thus, the circular groove may also prolong the tool life or durability of the mold casing, since abrasive compound may not bleed into the gap or back into the mold cavity.

It should be mentioned that already the providing of the groove feature may be a suitable way to reduce flashes introduced into a through hole or onto a molded encapsulation. Such a groove may be filled with molding material during a first use of the ejector pin and this molding material may remain in the groove after the first use cycle. In the subsequent uses of the ejector pin this “old” (and cured) molding material may stick to the groove and act as a barrier or stop for the new molding material filled in the mold casing the ejector pin is used in. Thus, it is clear that no specific material has to be used to form a circumferential ring or annulus in the groove, since this may be done automatically during the first use of the ejector pin. Therefore, already the provision of an ejector pin having a grove or depression feature may be a suitable provision to effectively reduce or avoid the possibility of remaining molding material to obstruct a through hole in a mold casing or cavity.

In the following exemplary embodiments of the ejector pin are described. However, the features and elements described with respect to these embodiments can be combined with exemplary embodiments of the mold and the method of manufacturing an ejector pin.

According to an exemplary embodiment of the ejector pin the circumferential groove has a depth which is at least 20 micrometer. In particular, the depth may be in the range of 50 micrometer to 1000 micrometer, e.g. about 150 to 200 micrometer.

According to an exemplary embodiment of the ejector pin the circumferential groove has a depth which is in the range of 5% to 40% of a diameter of the pin shaft.

In particular, the depth may be in the range of 10% to 30%, e.g. about 15% to 20% of the diameter of the pin shaft.

According to an exemplary embodiment of the ejector pin the ejector pin comprises a material out of the group consisting of metal, e.g. steel, tool steel, beryllium copper (beryllium-copper alloy comprising 0.5% to 3% beryllium), aluminum (e.g. hard aluminum alloy 2024 or 7075), and plastic.

According to an exemplary embodiment of the ejector pin the circumferential groove is filled with a filling material different from a material of the pin shaft.

In particular, the material filling the groove or filling material may form a ring or annulus. For example, the filling material may totally fill the groove, preferably the filling material may even projects circumferential beyond the surface of the pin shaft. Alternatively, the filling material may be flush with or recessed with respect to the circumferential surface of the pin shaft.

According to an exemplary embodiment of the ejector pin the filling material has a higher coefficient of thermal expansion than the material of the pin shaft.

By using a filling material having a higher coefficient of thermal expansion it may be possible that the filling material forms a kind of sealing during a molding process filling a gap between the pin shaft and the mold during the molding process typically associated with an increased temperature level compared to room temperature.

According to an exemplary embodiment of the ejector pin the filling material is one out of the group consisting of teflon; rubber; resin; molding material.

In principle any material may be used as a filling material which will form a ring or annulus remaining in the circumferential groove and thus may act as a stop or stopper for the molding material to stop it from bleeding into the gap between the ejector pin and the mold casing. For example, the filling material may be prefabricated into a ring or annulus which is then fixed in the groove. Preferably the filling material may be a material withstanding high temperatures, i.e. temperatures typically present during molding processes.

In the following exemplary embodiments of the mold are described. However, the features and elements described with respect to these embodiments can be combined with exemplary embodiments of the ejector pin and the method of manufacturing an ejector pin.

According to an exemplary embodiment the mold comprising a circumferential gap between the pin shaft and the through hole.

Such a gap may be in particular useful for providing for an efficient and easy movement of the ejector pin in the mold casing. At the same time the circumferential groove at the ejector pin may help to prevent that mold material or molding compound may bleed into this gap.

In the following exemplary embodiments of the method of forming an ejector pin are described. However, the features and elements described with respect to these embodiments can be combined with exemplary embodiments of the ejector pin and mold.

According to an exemplary embodiment the method further comprises filling the circumferential groove with a filling material.

It should be mentioned that the filling may be performed by introducing or insertion of a prefabricated ring or annulus into the circumferential groove, e.g. by using a Teflon or rubber ring. Alternatively, the filling may be performed during a first use of the ejector pin in a mold process in which some molding material or molding compound may enter into the circumferential groove and may stick to the ejector pin in the groove even in further molding cycles of the same mold including the ejector pin. In particular, the molding material present in the circumferential groove may be cured as well during the curing process of the encapsulation. Thus, it may stick to the ejector pin and may not melt during subsequent molding cycles.

According to an exemplary embodiment of the method the filling material has a coefficient of thermal expansion which is higher than a coefficient of thermal expansion of the material of the ejector shaft.

By using a material having a higher coefficient of thermal expansion than the material of the ejector pin or pin shaft it may be possible to provide an efficient way to stop the entering of molding material into the gap due to a thermal expansion of the filling material. Thus, it may be possible that while the ejector pin still can be moved in the through or ejector pin hole the gap may be efficiently be sealed by the filling material during the molding process at which the ejector pin is subjected to an increased temperature due to the liquid molding material or molding compound.

In the following specific embodiments of the ejector pin, the mold and the method of manufacturing an ejector pin will be described in more detail with respect to the figures.

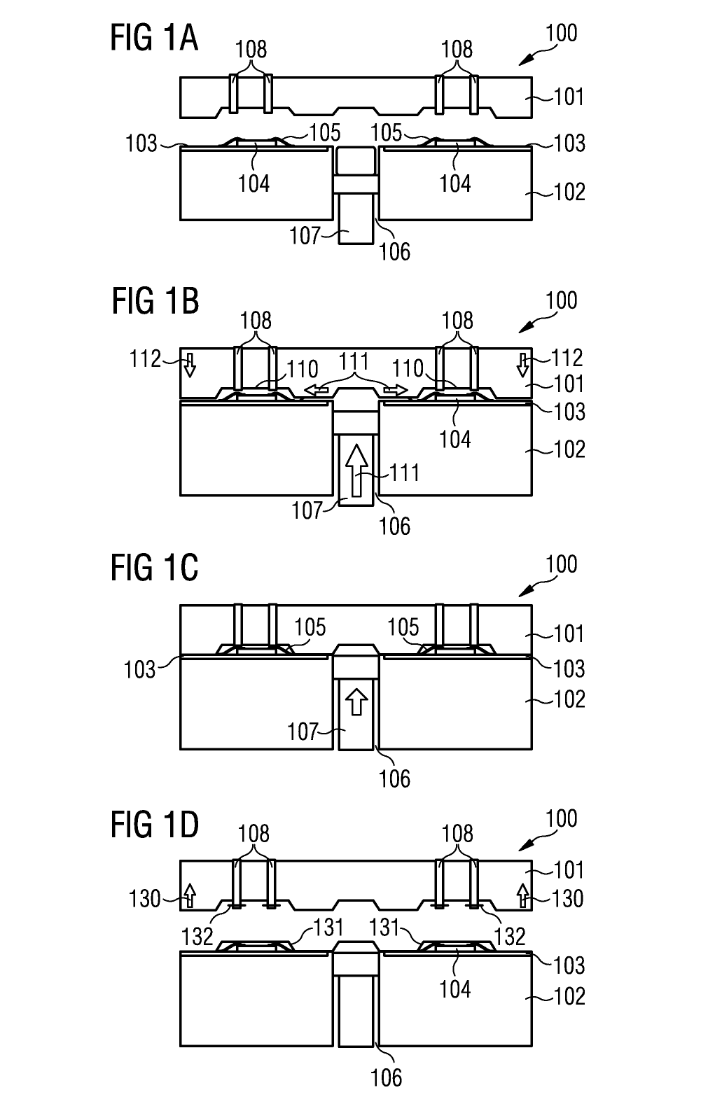

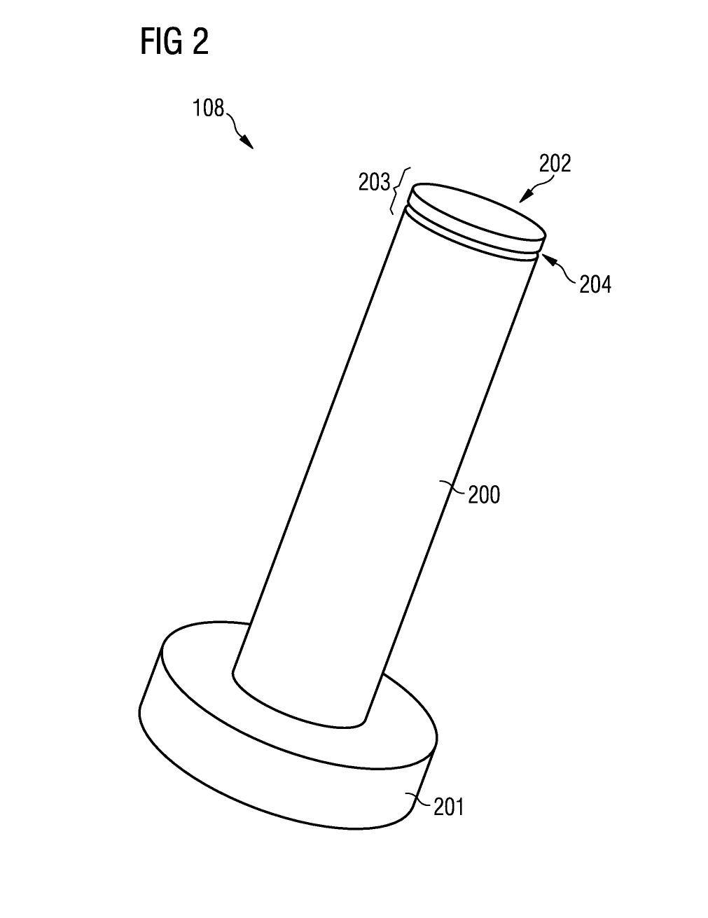

FIGS. 1A to 1D schematically illustrate a first cycle of a molding process using a mold according to an exemplary embodiment. In particular, FIG. 1A shows a mold 100 comprising a mold casing formed by an upper part 101 and a lower part 102. On the lower part 102 substrates (or a leadframe) 103 are arranged on which electronic chips or dies 104 are placed which are connected to the substrate via wires 105. Furthermore, a hole 106 is formed in the lower part in which a transfer unit 107 is inserted for transferring molding material or molding compound during the molding process and encapsulate the substrates, chips and wires. The upper part 101 comprises a plurality of through or ejector pin holes in which ejector pins 108 are inserted. An exemplary ejector pin 108 will be shown and explained in more detail in the context of FIG. 2.

FIG. 1B shows the mold 100 of FIG. 1A after the upper part 101 is lowered onto (indicated by arrows 112) the lower part 102 so that closed mold cavities or molding areas 110 are formed by the upper part 101 and the lower part 102. Then the molding compound is transferred into the molding cavities via the transfer unit 107 which is indicated by the arrows 111.

FIG. 1C shows a later stage of the step in which the molding compound is transferred and in which the whole molding cavities are filled by the molding compound or molding material. Subsequently the molding material is cured and the mold casing is opened by lifting the upper part from the lower part 102 (indicated by arrows 130) and the ejector pins 108 are used to separate the molded products or chip packages 131 from the upper part 101. Furthermore, small projections 132 are indicated in FIG. 1D on the ejector pins 108 which shall schematically indicate cured molding material which stick to the ejector pins, which will be explained in more detail in the context of the next figures.

FIG. 2 shows an ejector pin 108 according to an exemplary embodiment in detail. In particular, the ejector pin 108 comprises a pin shaft 200 comprising a pinhead 201 at one end and a tip end 202 at the opposite end of the pin shaft. At the pin tip 202 a butting region is schematically indicated as 203 which extends over some length of the pin shaft 200. In the butting region 203 a circumferential groove or depression feature 204 is formed. It should be noted that this groove may be filled by molding material during a first molding cycle as described in the context of FIGS. 1A to 1D and will facilitate the sticking of a ring or annulus of cured molding material to the ejector pin 108 possibly leading to a reduced bleeding of molding material into a gap between the molding casing and the ejector pin.

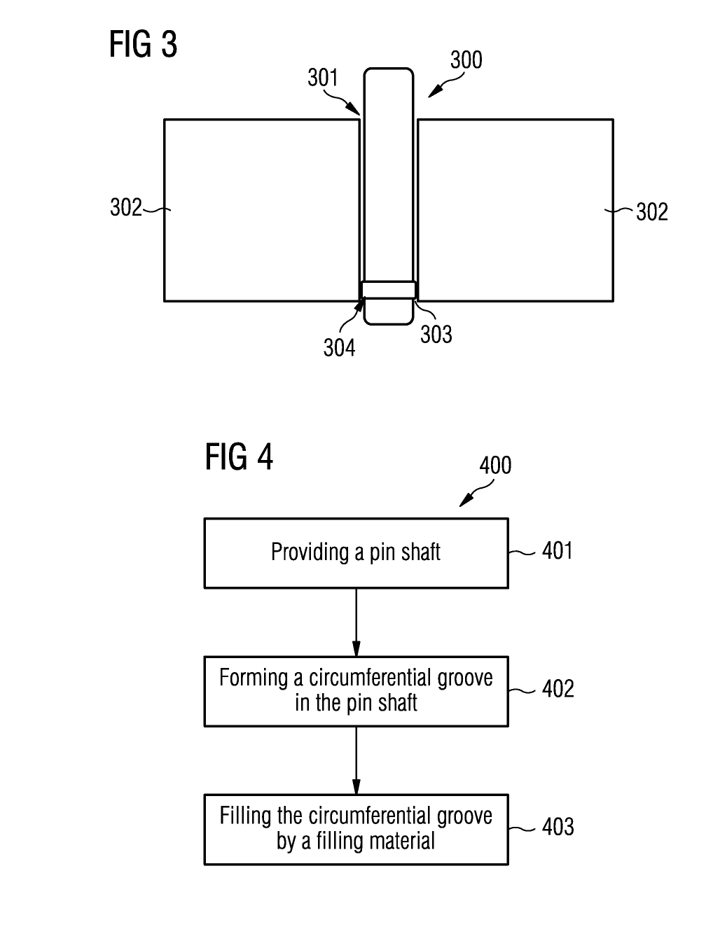

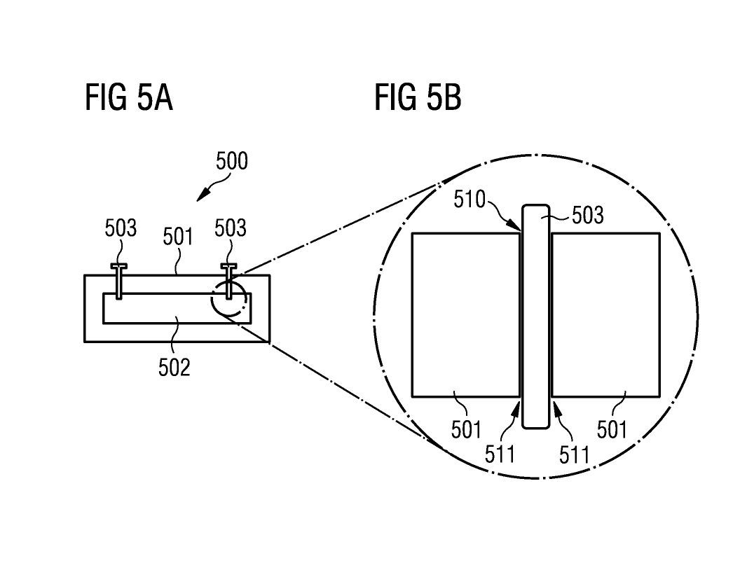

FIG. 3 schematically shows an ejector pin 300 according to an exemplary embodiment. In particular, FIG. 3 shows the ejector pin 300 introduced into an ejector pin hole 301 formed in a mold casing 302. As can be seen in FIG. 3 a gap 303 is present between the ejector pin 300 and the mold casing which is intended to facilitate the movement of the ejector pin. However, ejector pin 300 comprises a ring 304 or annulus of filling material arranged at a tip end and/or a butting region of the ejector pin, wherein the ring closes or at least reduces the gap at or close to the tip end of the ejector pin. Thus, it may be possible to avoid or at least reduce the amount of molding material or molding compound which flows or bleeds otherwise into the gap forming flashes which may then (in a subsequent molding process or cycle) leads to detrimental deposition of these flashes on or in the encapsulation formed in this subsequent molding process.

It should be noted that the ring may consist of a prefabricated ring, e.g. made of Teflon, rubber, plastic or another suitable material, fixed in a groove of the ejector pin or may be formed from cured molding material filling the groove in a first molding process.

FIG. 4 illustrates a flowchart of a method of manufacturing an ejector pin 400 according to an exemplary embodiment. In a first step 401 a pin shaft comprising a pinhead at a pinhead end is provided. In a next step 402 a circumferential groove is formed in the pin shaft at a butting region at a tip end of the pin shaft, wherein the tip end is opposite to the pinhead end. Optionally the circumferential groove may be filled with a filling material like a preformed ring of rubber or Teflon.

It should also be noted that the term “comprising” does not exclude other elements or features and the “a” or “an” does not exclude a plurality. Also elements described in association with different embodiments may be combined. It should also be noted that reference signs shall not be construed as limiting the scope of the claims. While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An ejector pin for a mold, the ejector pin comprising:
a pin shaft comprising a pinhead at one end and a butting region at the opposite end of the pin shaft, wherein a circumferential groove is formed in the pin shaft at the butting region.

2. The ejector pin according to claim 1, wherein the circumferential groove has a depth which is at least 20 micrometer.

3. The ejector pin according to claim 1, wherein the circumferential groove has a depth which is in the range of 5% to 40% of a diameter of the pin shaft.

4. The ejector pin according to claim 1, wherein the ejector pin comprises a material out of the group consisting of:
metal; and
plastic.

5. The ejector pin according to claim 1, wherein the circumferential groove is filled with a filling material different from a material of the pin shaft.

6. The ejector pin according to claim 5, wherein the filling material has a higher coefficient of thermal expansion than the material of the pin shaft.

7. The ejector pin according to claim 5, wherein the filling material is one out of the group consisting of:
Teflon;
rubber;
resin;
molding material.

8. A mold comprising:
a mold housing comprising a through hole; and
an ejector pin according to claim 1,
wherein the ejector pin is inserted in the through hole.

9. The mold according to claim 8, comprising a circumferential gap between the pin shaft and the through hole.

10. A method of forming an ejector pin, the method comprising:
providing a pin shaft comprising a pinhead at a pinhead end; and
forming a circumferential groove in the pin shaft at a butting region at a tip end of the pin shaft, wherein the tip end is opposite to the pinhead end.

11. The method according to claim 10, further comprising:
filling the circumferential groove with a filling material.

12. The method according to claim 11, wherein the filling material has a coefficient of thermal expansion which is higher than a coefficient of thermal expansion of the material of the ejector shaft.
